(19) United States
(12) Patent Application Publication
(10) Pub. No.: US 2022/0301292 A1
(43) Pub. Date: Sep. 22, 2022

(54) TARGET OBJECT DETECTION DEVICE, TARGET OBJECT DETECTION METHOD, AND NON-TRANSITORY COMPUTER READABLE STORAGE MEDIUM STORING TARGET OBJECT DETECTION PROGRAM

(71) Applicant: MITSUBISHI HEAVY INDUSTRIES, LTD., Tokyo (JP)

(72) Inventors: Kenta NAKAO, Tokyo (JP); Kiichi SUGIMOTO, Tokyo (JP); Satoshi IIO, Tokyo (JP)

(21) Appl. No.: 17/678,226

(22) Filed: Feb. 23, 2022

(30) Foreign Application Priority Data
Mar. 19, 2021 (JP) 2021-046090

(51) Int. Cl. G06V 10/77; G06V 10/75; G06V 10/74

(52) U.S. Cl. CPC G06V 10/7715; G06V 10/751; G06V 10/761

(57) ABSTRACT

A target object detection device comprising a camera unit that acquires an image at a predetermined time interval; an image processing unit that extracts a target object from the image acquired; a comparison unit that compares the target object extracted from the image with a target object extracted from an image of a frame before the image; a storage unit that stores a weighting condition based on a position on an image between the target object extracted from the image and the target object extracted from the image of a frame before the image; and an identification unit that compares a comparison result of the comparison unit based on the weighting condition and identifies the target object extracted from the image of a frame before the image that matches the target object extracted from the image.

### CROSS-REFERENCE TO RELATED APPLICATIONS

This application claims the benefit of priority to Japanese Patent Application Number 2021-046090 filed on Mar. 19, 2021. The entire contents of the above-identified application are hereby incorporated by reference.

### TECHNICAL FIELD

The disclosure relates to a target object detection device, a target object detection method, and a non-transitory computer readable storage medium storing a target object detection program.

### RELATED ART

There is a target object detection device that analyzes an image acquired by a camera or the like and detects a target object included in the image. The target object detection devices include a device that detects a plurality of target objects and tracks each target object.

JP 2020-107349 A discloses a target object tracking system including: a plurality of detection means for detecting a target object from a captured image and outputting a detection result; and integrated tracking means for calculating position information on the target object expressed in a common coordinate system on the basis of the plurality of detection results output by each of the plurality of detection means, in which the integrated tracking means outputs position information on a target object of a calculated common coordinate system, and the detection means is configured to: convert the position information on the target object on the common coordinate system into position information represented with an individual coordinate system feature of a camera outputting an image of the target object serving as a target of detection; track the target object on the individual coordinate system; detect the target object based upon the position information represented with the individual coordinate system; and convert the position information on the target object, detected based on the position information represented with the individual coordinate system, into position information represented with the common coordinate system.

### SUMMARY

Here, in a case where a plurality of target objects resemble or in a case where a shape changes greatly from a previous image of the comparison target, the same target object cannot be appropriately determined, and there is a possibility that a different target object is detected as the same target object, or the same target object is detected as a different target object.

An object of at least one embodiment of the disclosure is to provide a target object detection device, a target object detection method, and a non-transitory computer readable storage medium storing a target object detection program that can identify a target object and highly accurately perform association of the same target object.

The disclosure provides a target object detection device including: a camera unit that acquires an image at a predetermined time interval; an image processing unit that extracts a target object from the image acquired; a comparison unit that compares the target object extracted from the image with a target object extracted from an image of a frame before the image; a storage unit that stores a weighting condition based on a position on an image between the target object extracted from the image and the target object extracted from the image of a frame before the image; and an identification unit that compares a comparison result of the comparison unit based on the weighting condition and identifies the target object extracted from the image of a frame before the image that matches the target object extracted from the image.

The disclosure provides a target object detection method including: acquiring an image at a predetermined time interval; extracting a target object from the image acquired; comparing the target object extracted from the image with a target object extracted from an image of a frame before the image; reading a weighting condition based on a position on an image between the target object extracted from the image and the target object extracted from the image of a frame before the image; and comparing a comparison result of the comparison unit based on the weighting condition and identifying the target object extracted from the image of a frame before the image that matches the target object extracted from the image.

The disclosure provides a non-transitory computer readable storage medium storing a target object detection program that causes a computer to execute processing including: acquiring an image at a predetermined time interval; extracting a target object from the image acquired; comparing the target object extracted from the image with a target object extracted from an image of a frame before the image; reading a weighting condition based on a position on an image between the target object extracted from the image and the target object extracted from the image of a frame before the image; and comparing a comparison result of the comparison unit based on the weighting condition and identifying the target object extracted from the image of a frame before the image that matches the target object extracted from the image.

The configuration described above achieves an effect of being able to identify a target object and highly accurately perform association of the same target object.

### BRIEF DESCRIPTION OF DRAWINGS

The disclosure will be described with reference to the accompanying drawings, wherein like numbers reference like elements.

FIG. 1 is a block diagram illustrating an example of a target object detection device.

FIG. 2 is a flowchart illustrating an example of processing of the target object detection device.

FIG. 3 is an explanatory diagram schematically illustrating an example of an image to be processed.

FIG. 4 is an explanatory diagram for describing an example of processing of a comparison unit and an identification unit.

FIG. 5 is an explanatory diagram for describing an example of processing of the comparison unit and the identification unit.

FIG. 6 is an explanatory diagram for describing an example of processing of the comparison unit and the identification unit.

FIG. 7 is an explanatory diagram for describing an example of processing of the comparison unit and the identification unit.

FIG. 8 is an explanatory diagram for describing an example of processing of the comparison unit and the identification unit.

### DESCRIPTION OF EMBODIMENTS

Hereinafter, embodiments according to the disclosure will be described in detail with reference to the drawings. Note that, the disclosure is not limited to the embodiments. In addition, components in the following embodiments include components that can be easily replaced by those skilled in the art or substantially the same components. Furthermore, the components described below can be appropriately combined, and when there are a plurality of embodiments, each embodiment can be combined.

### Target Object Detection Device

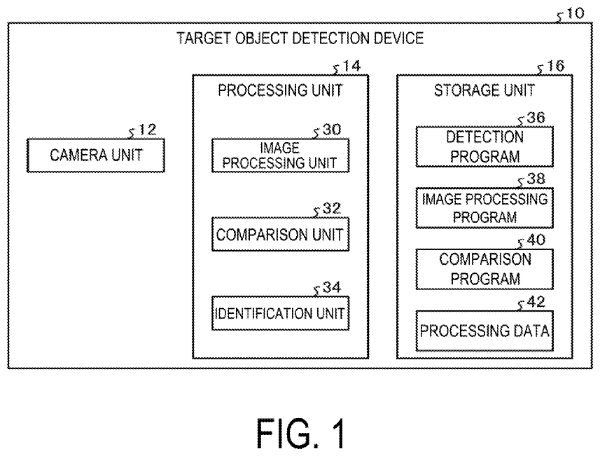

FIG. 1 is a block diagram illustrating an example of the target object detection device. A target object detection device 10 according to the present embodiment acquires an image and detects a target object from the acquired image. The target object detection device 10 repeats detection of the target object on the image acquired in units of predetermined time, and identifies an identical target object among the target objects included in images of different times (different frames). The target object detection device 10 is installed in, for example, a moving body such as a vehicle and a flying object, and a building. The target object is not particularly limited and can be various categories of target objects such as humans, machines, dogs, cats, vehicles, and plants.

As illustrated in FIG. 1, the target object detection device 10 includes a camera unit 12, a processing unit 14, and a storage unit 16. The target object detection device 10 may further include an input unit, an output unit, and a communication unit. Here, the output unit includes a display that displays an analysis result of an image, and a speaker, a light emitting device, a display that output a warning based on a detection result.

The camera unit 12 acquires an image included in a photographing region. The camera unit 12 captures an image at an interval of a predetermined period of time. The camera unit 12 may continuously acquire images at a predetermined frame rate or may acquire images with a predetermined operation as a trigger.

The processing unit 14 includes an integrated circuit (processor) such as a central processing unit (CPU) or a graphics processing unit (GPU) and a memory serving as a workspace, and executes various types of processing by executing various programs using these hardware resources. Specifically, the processing unit 14 executes various types of processing by reading a program stored in the storage unit 16, loading the program into the memory, and causing the processor to execute an instruction included in the program loaded into the memory. The processing unit 14 includes an image processing unit 30, a comparison unit 32, and an identification unit 34. Before each unit of the processing unit 14 is described, the storage unit 16 will be described.

The storage unit 16 includes a non-volatile storage device such as a magnetic storage device and a semiconductor storage device, and stores various programs and data. The storage unit 16 includes a detection program 36, an image processing program 38, a comparison program 40, and processing data 42.

The data stored in the storage unit 16 include the processing data 42. The processing data 42 includes: image data acquired in the camera unit 12, and position, size, comparison results, and the like of the target object extracted from the image data. The processing data 42 may be classified and stored for each target object position. The processing data 42 may include partially processed data. The storage unit 16 stores processing conditions and the like of each program.

The programs stored in the storage unit 16 include the detection program 36, the image processing program 38, and the comparison program 40. The detection program 36 controls operations of the image processing program 38 and the comparison program 40, and executes the target object detection processing. The detection program 36 executes processing of detecting and comparing a target object from an image and executes processing of identifying the target object.

The image processing program 38 executes image processing on the image acquired by the camera unit 12, and extracts the target object included in the image. Various programs can be used as the image processing program 38, and a learned program that has learned extraction of the target object in a deep learning model can be used. As a deep learning model, it is possible to use a deep learning model such as Regions with Convolutional Neural Networks (R-CNN), You Only Look Once (YOLO), or Single Shot multibox Detector (SSD), in which a bounding box called an anchor is set for an image and a feature in the anchor based on the setting is processed to detect whether a target object is included in the image. The image processing program 38 may extract the target object by pattern matching or the like. The image processing program 38 calculates information on a region indicating the position at which the target object is extracted and information indicating features in the region. The image processing program 38 stores the extracted information in the processing data 42.

The comparison program 40 compares the result of extracting the target object between frames, identifies whether the same target object is extracted between frames, and identifies the identity of each target object.

In the storage unit 16, the detection program 36, the image processing program 38, and the comparison program 40 may be installed by reading the detection program 36, the image processing program 38, and the comparison program 40 that are recorded in a recording medium, or the detection program 36, the image processing program 38, and the comparison program 40 may be installed by reading the detection program 36, the image processing program 38, and the comparison program 40 that are available on a network.

The function of each unit of the image processing unit 30 will be described. Each unit of the image processing unit 30 executes a function by processing a program stored in the storage unit 16. The image processing unit 30 processes and executes the image processing program 38. The image processing unit 30 extracts the target object from the image captured by the camera unit 12 as described above.

The comparison unit 32 is implemented by executing the processing of the comparison program 40. The comparison unit 32 compares the information processed by the image processing unit 30 between frames of the image and outputs the information of the comparison result. The comparison unit 32 calculates the relationship between the compared frames. The relationship is calculated from 0 to 1 in the present embodiment, and the closer to 1, the higher the relationship, that is, the result of calculation is likely to be the same target object. Note that the value of the relationship is one example, and the relationship may be 1 or more or a negative number. Here, the comparison unit 32 calculates relationships based on information such as pattern matching of the image in the region, amount of change of the region, and features obtained by filtering.

The identification unit 34 is implemented by executing the processing of the comparison program 40. The identification unit 34 calculates a weighting coefficient for the target object and each combination of the target objects between the frames on the basis of preset weighting conditions. The identification unit 34 corrects, with the weighting coefficient, the relationship of the target object between the frames to be compared calculated by the comparison unit 32. The identification unit 34 identifies the same target object (the same photographic subject) between the frames on the basis of the relationship of the target object between the corrected frames.

The weighting coefficient is determined based on the weighting conditions such as the distance of the target object, i.e., the difference between the position of the target object in a preceding frame and the position of the target object in a subsequent frame. The weighting coefficient of the present embodiment is a value from 0 to 1. Note that the range of the weighting coefficient is an example, and may be 1 or more or a negative number.

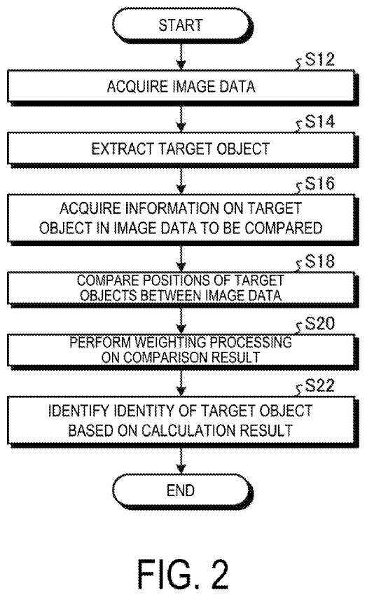

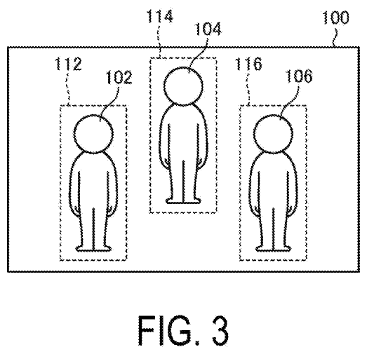

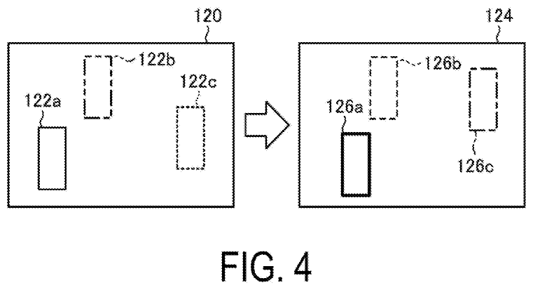

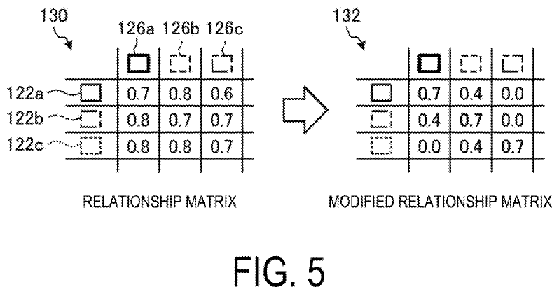

Next, an example of processing of the target object detection device 10 will be described with reference to FIGS. 2 to 5. FIG. 2 is a flowchart illustrating an example of processing of the target object detection device. FIG. 3 is an explanatory diagram schematically illustrating an example of an image to be processed. FIG. 4 is an explanatory diagram for describing an example of processing of the comparison unit and the identification unit. FIG. 5 is an explanatory diagram for describing an example of processing of the comparison unit and the identification unit. The description below assumes a human as the target object.

The target object detection device 10 acquires image data (step S12). Specifically, the target object detection device 10 acquires an image 100 illustrated in FIG. 3. The image 100 is an image that includes three persons 102, 104, and 106.

The target object detection device 10 extracts the target object (step S14). Specifically, in the case of the image 100, the target object detection device 10 executes processing on the image 100, and extracts a region 112 in which the person 102 is displayed, a region 114 in which the person 104 is displayed, and a region 116 in which the person 106 is displayed.

The target object detection device 10 acquires information on the target object of the image data to be compared (step S16). The target object detection device 10 acquires information on the extraction result of the target object in an image that has been processed before the image from which the target object has been extracted, in other words, the image of the frame before the frame of the image. Specifically, as illustrated in FIG. 4, in a case where target objects 126a, 126b, and 126c of an image 124 of a frame t have been extracted, the target object detection device 10 acquires information on target objects 122a, 122b, and 122c of an image 120 extracted from the image 120 of a frame t−1 before the image 124.

The target object detection device 10 compares the position and the like of the target object between the image data (step S18). The target object detection device 10 calculates a relationship matrix 130 illustrated in FIG. 5 by comparing the position and shape of the target object between the image data. In the case of the present embodiment, three target objects are detected in the image. In this case, the relationship matrix 130 calculates a relationship value for each of the target objects 122a, 122b, and 122c of the frame t−1 and the target objects 126a, 126b, and 126c of the frame t. The relationship value is a similarity degree calculated by the size and position of the region, the match degree of the image included in the region, and the like.

The target object detection device 10 executes weighting processing on the comparison result (step S20). The processing of FIG. 5 performs weighting according to the distance of the target object. Executing the weighting processing transforms the relationship matrix 130 into a relationship matrix (modified relationship matrix) 132. Specifically, for the position of the detection result of the image 120 in the frame t−1, distances D1 . . . DN from positions (X1ₜ, Y1ₜ) . . . (XNₜ, YNₜ) in each of the image of the detection results of the image 124 in the frame t. Next, the distances D1 . . . DN are arranged in ascending order (that is, the order of being close in distance), and assigned with predetermined weighting coefficients in order. The weighting coefficients are assigned proportionally such that the relationship of the nearest distance is 1.0 and the relationship of the farthest distance is 0.0. The target object detection device 10 multiplies the calculated weighting coefficient by the relationship value (similarity degree) of the corresponding combination.

The target object detection device 10 identifies the identity of the target object on the basis of the calculation result (step S22). The target object detection device 10 identifies a correspondence relationship of the target object on the basis of the calculated relationship matrix 132. In the case of the example illustrated in FIGS. 4 and 5, the same target object is identified on the basis of the combination in which the sum of the calculated relationship values becomes the highest. Specifically, the target objects having a relationship value of 0.7 are regarded as the same target object.

By calculating the weighting coefficient on the basis of the weighting condition for the relationship value obtained from comparison of the target objects extracted from the image and by correcting the relationship value, the target object detection device 10 can identify the identity of the target object included in the image with a higher degree of accuracy. Even when a plurality of similar target objects exist in an image and the relationship value increases, the target object detection device 10 can improve the accuracy of association by modifying the relationship value using position information in each frame. By executing processing based on the weighting conditions and making the similarity degree calculation for associating the detection result of each frame to be robust, the target object detection device 10 can perform accurate association even in a case of similar target objects and even in a case where the distance is so close that hiding or attitude changes occur, and can stable target object tracking.

As in the present embodiment, by calculating the weighting coefficient on the basis of the distance of the target object, it is possible to evaluate the similarity in a movable range between frames. This makes it possible to enhance the accuracy of identification of the same target object even in a case where the target objects have similarity as described above.

Here, the weighting condition may be set as a coefficient of a fixed value with respect to the order of the distance of the target object to be compared. For example, a nearest target object may be assigned with 1, a next nearest target object may be assigned with 0.5, and subsequent target objects may be assigned with 0. This can reduce the computation load of calculation of the weighting coefficient. As for the weighting condition, the weight may be 0 for a distance equal to or greater than a threshold of a predetermined distance, and in other cases, the weight may be as not changed. This enables a target object, which is moving across the range assumed between the frames, to be an evaluation target, and it is possible to prevent a target object from being detected as the same, at a position that does not occur unless having moved further.

The weighting condition may be weighted, similarly by predicting the position in the current frame, with respect to the detection result of the previous frame, using a Kalman filter or the like from the previous tracking result and by calculating the distance between the predicted position and the position of each detection result of the current frame. Thus, the distance may be evaluated based on a predicted position rather than an actual position of a previous frame.

In FIGS. 4 and 5, since the relationship value is equal to or greater than the threshold, the target object included in each of the two images correspond one to one, and they are identified as two images including the same target object. However, there is a case where the target object included in the image increases or decreases, or there is a case where one target object is eliminated and another target object is added with respect to the image of the previous frame.

When calculating the weighting coefficient based on the distance, it is preferable to adjust the allocation of the weighting coefficient to the distance based on the relative movement status. For example, in a case where the target object detection device is mounted on a moving body, it is preferable to change the weighting condition on the basis of the movement speed of the moving body. For example, when the moving body is moving at high speed, the weighting coefficient is set to be high even if the distance on the image is long. Similar setting is possible also based on an expected movement speed of the target object. This makes it possible to identify, with higher accuracy, whether the target object is the same, and possible to perform proper tracking.

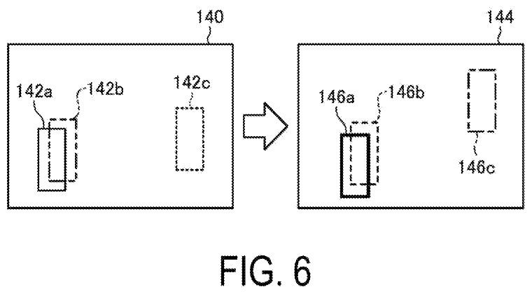

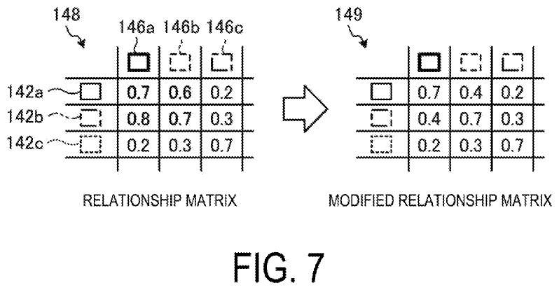

Here, the weighting condition is the distance of the target object, but the weighting condition is not limited to this. The weighting condition may be set based on the similarity degree of the target object. FIG. 6 is an explanatory diagram for describing an example of processing of the comparison unit and the identification unit. FIG. 7 is an explanatory diagram for describing an example of processing of the comparison unit and the identification unit. FIGS. 6 and 7 illustrate processing in which, in a case where a target object is present at a distance within a certain range, a weighting coefficient based on a similarity degree is set for a target object whose distance satisfies the condition, and the value of the relationship of the other target objects is not weighted (the coefficient is not corrected as 1).

As illustrated in FIG. 6, after acquiring the information on target objects 142a, 142b, and 142c in an image 140, the target object detection device 10 extracts target objects 146a, 146b, and 146c of an image 144 in a frame (current frame) after the image 140.

Next, by comparing the position and shape of the target object between the image data, the target object detection device 10 calculates a relationship matrix 148 illustrated in FIG. 7. In the case of the present embodiment, three target objects are detected in the image. In this case, the relationship matrix 148 calculates a relationship value for each of the target objects 142a, 142b, and 142c of the previous frame and the target objects 146a, 146b, and 146c of the subsequent frame. A detection result Aₜ of the subsequent frame that becomes the maximum similarity degree with respect to the detection result Aₜ₋₁ of the previous frame, and detection results Bₜ . . . Nₜ having a similarity degree, with which the difference from the maximum similarity degree becomes equal to or less than the threshold, are extracted.

Next, the target object detection device 10 only selects a detection result in which the distance from the position (X1ₜ₋₁, Y1ₜ₋₁) in the image of Aₜ₋₁ becomes equal to or less than the threshold with respect to the detection result of the extracted subsequent frame. The relationship matrix 148 illustrated in FIG. 7 extracts four combinations of the target object 142a and the target object 146a, the target object 142a and the target object 146b, the target object 142b and the target object 146a, and the target object 142b and the target object 146b.

Next, the target object detection device 10 newly performs similarity degree calculation processing on the combination of extracted target objects with each detection result of the subsequent frame and the detection result Aₜ₋₁ of the previous frame, and updates the similarity degree. Here, the dedicated similarity degree calculation processing used for the selected combinations uses a deep learning network that is robust to hidden or change of some features such as Siam RPN (*4) used, for example, in facial authentication. That is, calculation processing of a similarity degree, different from the calculation of the relationship value where the comparison unit calculates the relationship matrix, is used. The target object detection device 10 multiplies the calculated weighting coefficient of 1 or less by the target combination and calculates a relationship matrix 149. The new similarity degree calculation method is a method that is high processing load and high in accuracy than the calculation of the relationship value where the comparison unit calculates the relationship matrix.

Next, the target object detection device 10 identifies, based on the calculated relationship matrix 149, a combination of target objects to become identical, among target objects in the previous frame and target objects in the subsequent frame.

The target object detection device 10 can increase detection accuracy by further performing weighting processing on the basis of a similarity degree with respect to the calculated relationship matrix.

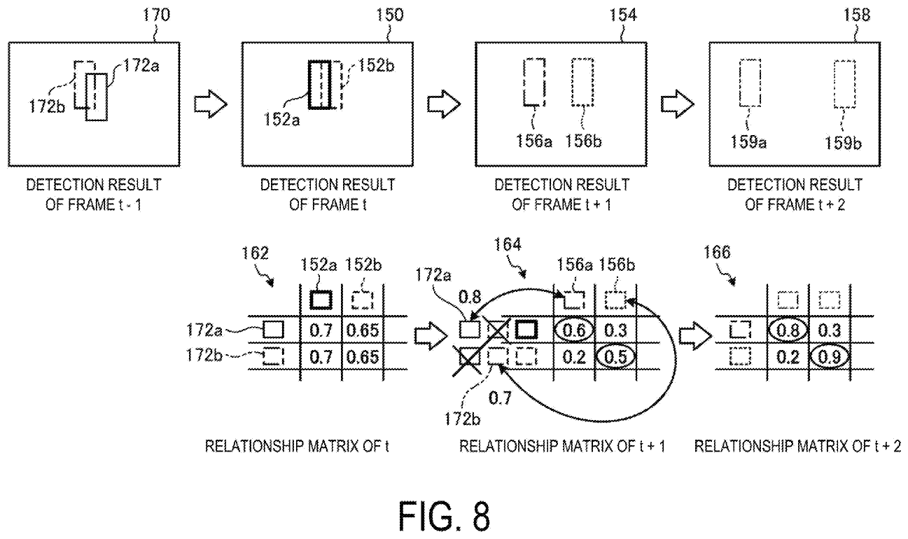

As in the present embodiment, the target object detection device 10 can also suppress an increase in the processing load, by extracting a target object having a near distance and by calculating the similarity degree only between the extracted target objects. Processing with high detection accuracy of similarity degree performs determinations, by generally deepening the processing layer in order to improve robustness and by using many features. Thus, due to high processing load, when such processing is adopted to all the similarity degree calculations between many target objects, the real-time properties will be reduced. That is, when such processing is applied to an initial relationship matrix, the processing load increases. The target object detection device 10 of the present embodiment performs initial similarity degree calculation by using a light-weight feature used in target object detection, and applies more accurate similarity degree calculation processing only to combinations of targets that satisfy a special relationship. This allows accurate similarity degree calculation even for a similar target object with the position in the image being near. The target object detection device 10 is not limited to a comparison between two frames, and a weighting condition may be set based on a comparison of three or more frames. FIG. 8 is an explanatory diagram for describing an example of processing of the comparison unit and the identification unit.

FIG. 8 illustrates a case of acquiring in a time series an image 170 of the frame t−1, an image 150 of the frame t, an image 154 of a frame t+1, and an image 158 of a frame t+2. Two target objects are detected in each of the images 170, 150, 154, and 158. For the image 170, target objects 172a and 172b are extracted. For the image 150, target objects 152a and 152b are extracted. For the image 154, target objects 156a and 156b are extracted. For the image 158, target objects 159a and 159b are extracted.

The target object detection device 10 calculates a relationship matrix 162 based on the image 150 of the frame t and the previous image 170 of the frame t−1. The relationship matrix 162 is a matrix indicating the relationship between the target objects 172a and 172b included in the image 170 of the frame t−1 and the target objects 152a and 152b included in the image 150 of the frame t. If the detection result Aₜ of the frame t that becomes the maximum similarity degree with respect to the detection result Aₜ₋₁ of the frame t−1 and the detection results Bₜ . . . Nₜ having a similarity degree, with which the difference from the maximum similarity degree becomes equal to or less than the threshold, exist, the target object detection device 10 temporarily performs temporary association to the Aₜ₋₁. In the relationship matrix 162, the similarity degree of each item becomes 0.7 or 0.65, and the combination of the target objects 152a and 152b and the target objects 172a and 172b cannot be determined. In this case, the relationship matrix 162 is temporarily associated. The target object detection device 10 also causes the feature of Aₜ₋₁ to be stored in the temporarily associated results Aₜ . . . Nₜ.

Based on the images of the frame t+1 and the frame t, a relationship matrix 164 is calculated. The relationship matrix 164 can determine the identity of the target object because the similarity degree of the target object 156a and the target object 152a is 0.6, the similarity degree of the target object 156b and the target object 152b is 0.5, and there is a significant difference with respect to the 0.2 and 0.3 of the other columns.

In a case of performing processing of the image of the frame t+1, the target object detection device 10 calculates a similarity degree also with Aₜ₋₁ when calculating the similarity degree with the detection results Aₜ₊₁ . . . Nₜ₊₁. That is, the similarity degree of the image of the frame t−1 and the image of the frame t+1 is also calculated. Here, if any of Aₜ₊₁ . . . Nₜ₊₁ (for example, Aₜ₊₁) has a higher similarity degree with Aₜ₋₁ than the similarity degree with Aₜ . . . Nₜ, Aₜ₊₁ is determined to be the same target object as Aₜ₋₁, and temporary association between Aₜ . . . Nₜ and Aₜ₋₁ is eliminated. At this time, the similarity degree of Aₜ, which is temporarily associated, is erased. As illustrated in FIG. 8, the target objects 156a and 156b of the image 154 are compared with the target objects 172a and 172b included in the image 170 of the frame t−1. In the example illustrated in FIG. 8, the match degree between the target object 172a and the target object 156a becomes 0.8, and the match degree between the target object 172b and the target object 156b becomes 0.7. Based on this result and the result that the similarity degree between the target object 156a and the target object 152a is 0.6 and the similarity degree between the target object 156b and the target object 152b is 0.5, the target object 172a and the target object 152a are determined to be the same, and the target object 172b and the target object 152b are determined to be the same. This result is reflected in the relationship matrix 164, and the temporary association is eliminated.

The target object detection device 10 performs association of images of the next frame t+2 and the frame t+1 and calculates a relationship matrix 166. The relationship matrix 166 has a distance of the target object that becomes equal to or greater than a predetermined distance, the difference in similarity degree increases and accuracy increases.

Thus, by performing the calculation processing on the similarity degree between a plurality of frames, it is possible to enhance the accuracy of identification of an identical target object between the frames. For example, even in a case where similar target objects are both temporarily hidden or attitude change occurs, it is possible to perform correct association by performing temporary association, storing the immediately preceding feature, and performing correction using the similarity degree with the frame at the time point when the hidden or attitude change is eliminated.

While preferred embodiments of the invention have been described as above, it is to be understood that variations and modifications will be apparent to those skilled in the art without departing from the scope and spirit of the invention. The scope of the invention, therefore, is to be determined solely by the following claims.

1. A target object detection device comprising:
a camera unit that acquires an image at a predetermined time interval;
an image processing unit that extracts a target object from the image acquired;
a comparison unit that compares the target object extracted from the image with a target object extracted from an image of a frame before the image;
a storage unit that stores a weighting condition based on a position on an image between the target object extracted from the image and the target object extracted from the image of a frame before the image; and
an identification unit that compares a comparison result of the comparison unit based on the weighting condition and identifies the target object extracted from the image of a frame before the image that matches the target object extracted from the image.

2. The target object detection device according to claim 1, wherein
the comparison unit calculates a relationship of target objects to be compared based on a comparison result, and
the identification unit identifies target objects having a high relationship as an identical target object.

3. The target object detection device according to claim 1, wherein
the weighting condition is a coefficient in which a value increases as a distance of target objects to be compared is nearer, and
the identification unit multiplies a comparison result by a weighting coefficient to identify whether or not target objects are identical.

4. The target object detection device according to claim 3, wherein as the weighting condition, a coefficient of a fixed value is set in order of distances of target objects to be compared.

5. The target object detection device according to claim 1, wherein
the weighting condition is a coefficient that is calculated with a calculation method of a similarity degree that is different from a calculation method of a similarity degree used in calculation of a comparison result of the comparison unit, the coefficient in which a value increases as a similarity degree of a target object to be compared is near, and
the identification unit multiplies a comparison result by a weighting coefficient to identify whether or not target objects are identical.

6. The target object detection device according to claim 5, wherein the weighting condition is calculation of a weighting coefficient for a target object with a distance of a target object to be compared being equal to or less than a threshold.

7. The target object detection device according to claim 1, wherein the comparison unit performs comparison using a target object extracted in a plurality of images of a frame before the image.

8. A target object detection method comprising:
acquiring an image at a predetermined time interval;
extracting a target object from the image acquired;
comparing the target object extracted from the image with a target object extracted from an image of a frame before the image;
reading a weighting condition based on a position on an image between the target object extracted from the image and the target object extracted from the image of a frame before the image; and
comparing a comparison result of the comparison unit based on the weighting condition and identifying the target object extracted from the image of a frame before the image that matches the target object extracted from the image.

9. A non-transitory computer readable storage medium storing a target object detection program that causes a computer to execute processing comprising:
acquiring an image at a predetermined time interval;
extracting a target object from the image acquired;
comparing the target object extracted from the image with a target object extracted from an image of a frame before the image;
reading a weighting condition based on a position on an image between the target object extracted from the image and the target object extracted from the image of a frame before the image; and
comparing a comparison result of the comparison unit based on the weighting condition and identifying the target object extracted from the image of a frame before the image that matches the target object extracted from the image.
